(19) United States
(12) Patent Application Publication
(10) Pub. No.: US 2023/0403446 A1
(43) Pub. Date: Dec. 14, 2023

(54) IMAGE DISPLAY DEVICE AND IMAGE DISPLAY METHOD

(71) Applicant: SHARP KABUSHIKI KAISHA, Osaka (JP)

(72) Inventor: TAKASHI KANDA, Osaka (JP)

(21) Appl. No.: 18/201,299

(22) Filed: May 24, 2023

(30) Foreign Application Priority Data
May 25, 2022 (JP) 2022-084883

(51) Int. Cl. H04N 23/12; G06T 7/11; G06T 7/33; G06T 7/62

(52) U.S. Cl. CPC H04N 23/12; G06T 7/11; G06T 2207/20172; G06T 7/62; G06T 2207/10024; G06T 7/33

(57) ABSTRACT

An image display device includes an image acquirer that acquires an input image, an object detector that detects a predetermined object from the input image, a size acquirer that acquires a size of the predetermined object, a determiner that determines whether to adjust an image quality for a specific color of the predetermined object based on the size of the predetermined object, an image quality adjuster that adjusts the image quality of at least a partial region of the input image for the specific color, and a display controller that controls a display panel to display the input image having the image quality adjusted.

### BACKGROUND OF THE INVENTION

### Field of the Invention

The present disclosure relates to an image display device, an image display method, and the like.

### Description of the Background Art

There are conventionally known methods for adjusting image qualities for a specific color in an image. For example, there is a method according to a known conventional technology in which the number of pixels including a specific color such as a skin color of a face is counted and, when the percentage of the pixels of the specific color is large based on the counting result, suitable correction is performed on a region of the specific color.

With the method according to the above conventional technology, it is determined whether to perform correction based on pixel information on the specific color such as the skin color. However, in situations where part of the face is hidden by a mask, sunglasses, etc., or the face is blurred, the number of pixels of the skin color is reduced. Therefore, with the method according to the above conventional technology, it may be difficult to perform suitable correction on the skin color of the face even when the percentage of the face in the input image is large.

According to some aspects of the present disclosure, it is possible to provide an image display device, an image display method, and the like, with which the image quality for the specific color may be properly adjusted.

### SUMMARY OF THE INVENTION

One aspect of the present disclosure is related to an image display device including an image acquirer that acquires an input image, an object detector that detects a predetermined object from the input image, a size acquirer that acquires a size of the predetermined object, a determiner that determines whether to adjust an image quality for a specific color of the predetermined object based on the size of the predetermined object, an image quality adjuster that adjusts, when the determiner determines that the image quality is to be adjusted, the image quality of at least a partial region of the input image for the specific color, and a display controller that controls a display panel to display the input image having the image quality adjusted.

Another aspect of the present disclosure is related to an image display method including acquiring an input image, detecting a predetermined object from the input image, acquiring a size of the predetermined object, determining whether to adjust an image quality for a specific color of the predetermined object based on the size of the predetermined object, adjusting, when it is determined that the image quality is to be adjusted, the image quality of at least a partial region of the input image for the specific color, and controlling a display panel to display the input image having the image quality adjusted.

### BRIEF DESCRIPTION OF THE DRAWINGS

FIG. 1 illustrates an example of an external appearance of a television receiver that is an example of an image display device.

FIG. 2 illustrates an example of a configuration of the television receiver that is an example of an image display device.

FIG. 3 illustrates an example of a configuration of the image display device.

FIG. 4 is a flowchart illustrating a process of the image display device.

FIG. 5 illustrates an example of an object detection result.

FIG. 6 is a flowchart illustrating a process of acquiring a size index value.

FIG. 7 illustrates an example of a relationship between a size statistic and a size index value.

FIG. 8A is a flowchart illustrating a process of determining whether an image quality for a specific color needs to be adjusted.

FIG. 8B is a flowchart illustrating a process of determining whether an image quality for a specific color needs to be adjusted.

FIG. 9A illustrates an example of time-series changes in an index value.

FIG. 9B illustrates an example of time-series changes in a hysteresis processing result.

FIG. 9C illustrates an example of time-series changes in a chattering filtering processing result.

FIG. 10 illustrates an example of a configuration of the image display device.

FIG. 11 is a flowchart illustrating a process of the image display device.

FIG. 12 is a diagram illustrating input and output during scene determination.

FIG. 13 illustrates an example of scene determination results (scene index value) and object detection results.

FIG. 14 is a flowchart illustrating a process of acquiring an index value.

### DESCRIPTION OF THE PREFERRED EMBODIMENTS

The present embodiment will be described below with reference to the drawings. In the drawings, the same or equivalent elements are denoted by the same reference numerals, and the duplicate description are omitted. The present embodiment described below does not unreasonably limit the content described in the scope of claims. Furthermore, all the configurations described according to the present embodiment are not necessarily essential configuration requirements for the present disclosure.

### 1. First Embodiment

### 1.1 System Configuration

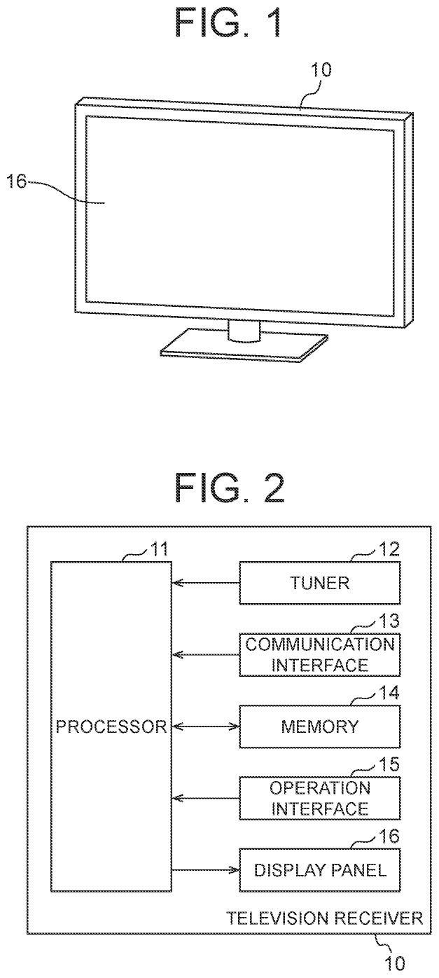

FIG. 1 is a diagram illustrating a configuration example of a television receiver 10 that is an example of an image display device 100 according to the present embodiment. The television receiver 10 is a device that receives, for example, broadcast waves for television broadcast and displays video based on the received broadcast waves on a display panel 16. FIG. 1 illustrates an example of the external configuration of the television receiver 10, and various modifications may be made to the specific shapes.

FIG. 2 is a diagram illustrating an example of the hardware configuration of the television receiver 10. The television receiver 10 includes a processor 11, a tuner 12, a communication interface 13, a memory 14, an operation interface 15, and the display panel 16. The configuration of the television receiver 10 is not limited to the one in FIG. 2, and various modifications may be made, such as omission of some configurations or addition of other configurations.

As the processor 11, various processors may be used, such as a central processing unit (CPU), graphics processing unit (GPU), or digital signal processor (DSP). The processor 11 may also include hardware such as an application specific integrated circuit (ASIC) or a field programmable gate array (FPGA). The processor 11 is coupled to each unit of the television receiver 10 to control each unit.

The tuner 12 includes an interface that receives broadcast waves for television broadcast at a specific frequency and circuitry, and the like, which performs processing on the received broadcast waves. For example, the interface here is a terminal to connect an antenna cable. The circuitry, and the like, here may include radio frequency (RF) circuitry, decoding circuitry to perform decoding, analog/digital conversion circuitry that perform A/D conversion, etc. The tuner 12 receives the signals corresponding to broadcast waves for television broadcast from an antenna and outputs video signals based on the signals to the processor 11. The video signals here are, for example, a set of time-series images acquired.

The communication interface 13 is an interface that performs communications in accordance with a communication method such as IEEE 802.11 and, in a narrow sense, is a communication chip to perform communications in accordance with the communication method. For example, the television receiver 10 communicates with a public communication network such as the Internet via the communication interface 13. Specifically, the television receiver 10 may connect to a content server via a public communication network and perform a process to receive video contents such as movies from the content server.

The memory 14 is a work area of the processor 11 to store various types of information. The memory 14 may be a semiconductor memory such as a static random access memory (SRAM) or a dynamic random access memory (DRAM), a register, a magnetic storage device such as a hard disk drive (HDD), or an optical storage device such as an optical disk device.

The operation interface 15 is an interface used by a user to operate the television receiver 10 and may be a button provided on a housing of the television receiver 10 or an interface (e.g., an infrared receiver) used to communicate with a remote controller.

The display panel 16 is a display that presents images. The display panel 16 may be, for example, a liquid crystal display, an organic EL display, or other type of display.

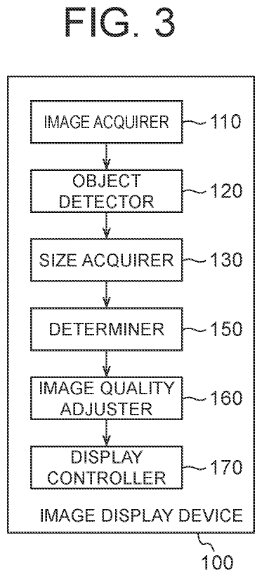

FIG. 3 is a diagram illustrating an example of the configuration of the image display device 100 according to the present embodiment. The image display device 100 includes an image acquirer 110, an object detector 120, a size acquirer 130, a determiner 150, an image quality adjuster 160, and a display controller 170. The configuration of the image display device 100 is not limited to the one in FIG. 3, and modifications may be made, such as addition and omission of configurations.

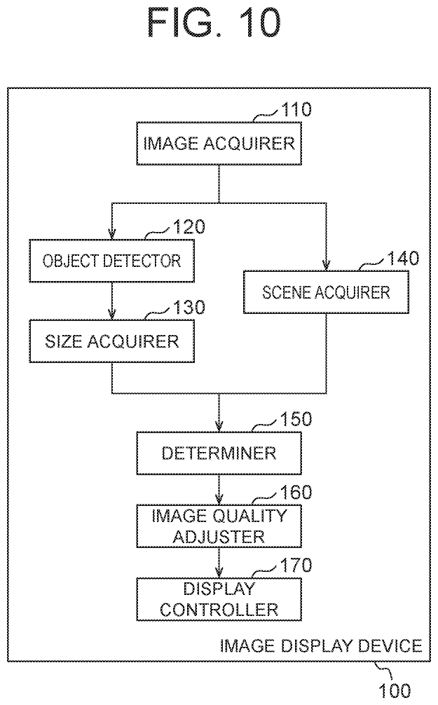

The image display device 100 according to the present embodiment corresponds to, for example, the television receiver 10 illustrated in FIG. 2. For example, each unit of the image display device 100 may be implemented by the processor 11 of the television receiver 10. For example, the memory 14 stores programs, various types of data, etc. More specifically, the memory 14 stores instructions readable by a computer, and the processor 11 executes the instructions to perform the function of each of the units of the image display device 100 illustrated in FIG. 3 as a process. The units of the image display device 100 include the image acquirer 110, the object detector 120, the size acquirer 130, the determiner 150, the image quality adjuster 160, and the display controller 170. The units of the image display device 100 may also include a scene acquirer 140, which is described below using FIG. 10. The instructions here may be instructions in an instruction set included in a program or an instruction for instructing an operation of hardware circuitry of the processor 11.

The image acquirer 110 acquires an input image. The input image here represents the image to be displayed on the display panel 16. For example, the input image may be an image included in a video signal for television broadcast acquired via the antenna and the tuner 12. The video signals here may be signals in accordance with Rec.709 (BT.709), which is a standard for coding, etc. in high-definition television broadcasting. In Rec.709, for example, RGB color space parameters are specified.

An example where the input image corresponds to video signals for television broadcast will be described below. The method according to the present embodiment is not limited thereto. For example, the input image may be an image included in video signals acquired by the communication interface 13 from the content server. The television receiver may be coupled to a playback device for a medium such as Blu-ray Disc (BD) (registered trademark), and the image included in the video signals read from the medium may also be used as the input image.

The object detector 120 detects a predetermined object from the input image. The predetermined object here is, for example, a human face. The predetermined object may be other objects such as a blue sky or a green landscape. The green landscape is, for example, a landscape with plants such as grass and trees.

For example, when the human face is the target, the object detector 120 may detect parts included in the face, such as eyes, mouth, or nose, and detect the human face from the input image based on the type and positional relationship of the detected parts. For example, the object detector 120 may detect the outline of the human face based on the positional relationship of the parts to specify the region corresponding to the face. During object detection, a process is performed to determine the presence or absence of the object and also specify the position and range where a predetermined object is present in the input image. Results of machine learning may also be used to detect an object from an image. For example, a convolutional neural network (CNN) may be used to set a detection window in part of the input image and determine whether a face is present in the region included in the detection window. The process is repeatedly performed while the size and shape of the detection window is changed so that a predetermined object may be detected from the input image. Various methods such as You Only Look Once (YOLO), which is suitable for real-time detection, are known as the method using a neural network, and may be widely applied according to the present embodiment. Furthermore, the object detection method is not limited to the above examples, and known methods may be widely applied.

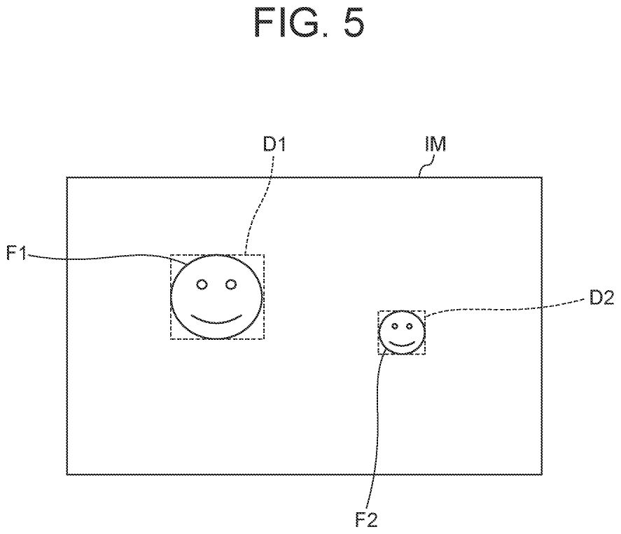

The size acquirer 130 acquires the size of the predetermined object detected by the object detector 120. For example, when a rectangular region D1, or the like, including the predetermined object is detected as a result of object detection, as described below with reference to FIG. 5, the size acquirer 130 may acquire the size based on the product of the vertical length (number of pixels) and the horizontal length (number of pixels) of the rectangular region.

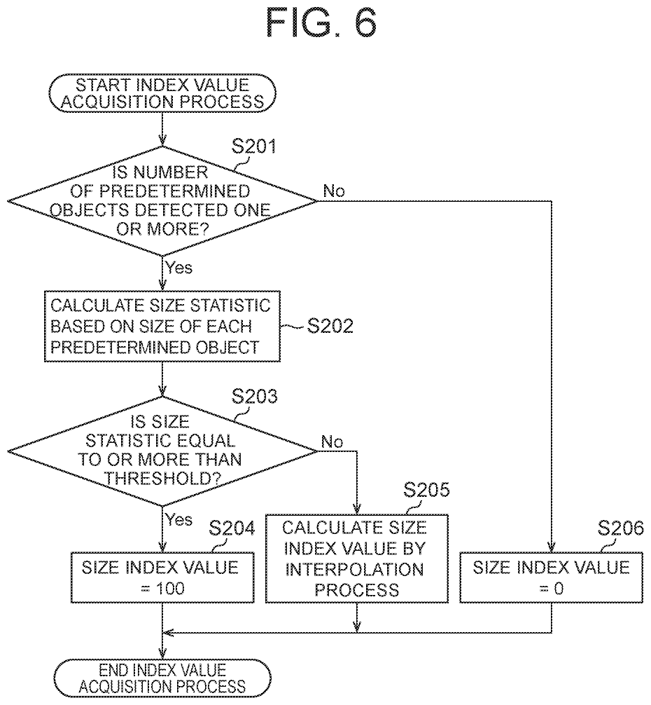

The determiner 150 determines whether to adjust the image quality for a specific color based on the size of the predetermined object. A specific determination method will be described below with reference to FIGS. 6 to 8B, etc.

When it is determined that the image quality is to be adjusted, the image quality adjuster 160 adjusts the image quality of at least a partial region of the input image for the specific color of the predetermined object. For example, a memory color is known as the color of the predetermined object that a person remembers as its image. The memory color is sometimes different from the actual color of the object. In this case, when the displayed image sticks closely to the actual color, the user who views the image may feel strange because the actual color differs from the memory color. Therefore, the image quality adjuster 160 may perform the process to adjust the image quality for the specific color included in the predetermined object to bring the shade of the specific color close to the memory color. For example, for the skin color of a human, it is known that the saturation of the memory color is lower than the actual one, and therefore the image quality adjuster 160 may perform the image quality adjustment process to reduce the saturation in the skin color region. Furthermore, for blue skies and green landscapes, it is known that the saturation of the memory color is higher than the actual one, and therefore the image quality adjuster 160 may perform the image quality adjustment process to increase the saturation of the blue region corresponding to the sky and the green region corresponding to the green landscape. The adjustment on the image quality is not limited to adjustment of the saturation, but may also include adjustment on brightness and hue. The adjustment on the image quality for the specific color according to the present embodiment is not limited to the adjustment based on the memory color.

The color space determined by the standard of television broadcast described above is sometimes narrower than the color space that may be expressed by the display panel 16. In this case, when the input image is displayed without change, it may be difficult to take advantage of the capability of the display panel 16 in expressing vivid colors. Therefore, the image quality adjuster 160 may perform the image quality adjustment process to increase at least one of the brightness and saturation for the input image regardless of the detection result of the object. For example, the image quality adjuster 160 may adjust the image quality for the input image by combining both the adjustment process for the specific color of the predetermined object and the adjustment process regardless of the object.

The display controller 170 controls the display panel 16 to display the input image having the image quality adjusted by the image quality adjuster 160. For example, the display controller 170 outputs, to the display panel 16, an image signal and a timing control signal that instructs the control timing of drive circuitry included in the display panel 16. The image quality adjustment for the specific color may be omitted depending on the determination of the determiner 150, and the image to be displayed here may be an image on which no adjustment for the specific color has been made.

Although the image display device 100 is the television receiver 10 in the example described above, it is not limited thereto. For example, the image display device 100 may correspond to a device such as a set-top box. In this case, the display control performed by the display controller 170 may be the control for outputting the input image having undergone the image quality adjustment to a device (the television receiver 10, the display, etc.) including the display panel 16.

In the method according to the present embodiment, the image quality for the specific color of the predetermined object is adjusted based on the result of object detection described above. There are various possible object detection methods as described above, but even when part of the predetermined object is hidden, for example, the predetermined object is detectable with high accuracy, which makes it possible to properly determine whether the image quality for the specific color needs to be adjusted. For example, in a case where the predetermined object is a face, even when the number of skin color pixels is reduced because part of the face is hidden by a mask, sunglasses, etc., it may be determined that the image quality adjustment is necessary when the size of the face is large. As a result, it is possible to prevent the occurrence of a failure in the image quality adjustment as compared to conventional methods using the number of pixels of the color corresponding to the specific color, the region where there are the successive pixels of the color, etc.

Some or all of the processes performed by the image display device 100 according to the present embodiment may be implemented by a program. The process performed by the image display device 100 is, for example, the process performed by the processor 11 of the television receiver 10.

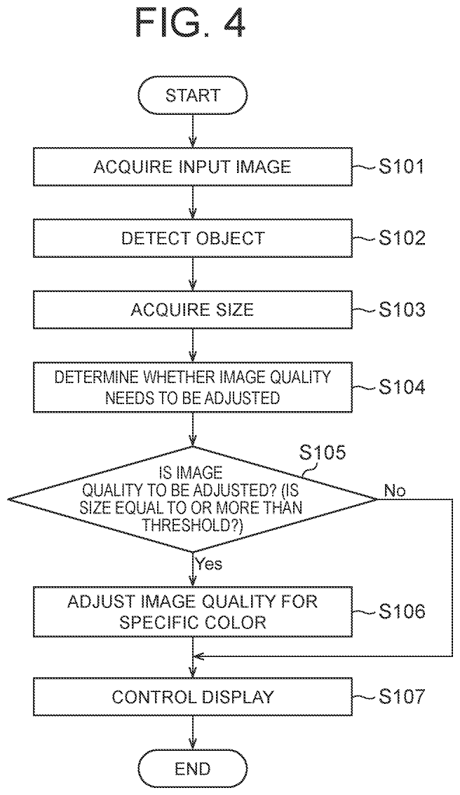

The program according to the present embodiment may be stored in a non-transitory information storage device (information storage medium) that is a medium readable by, for example, a computer. The information storage device may be implemented by, for example, an optical disk, a memory card, an HDD, or a semiconductor memory. The semiconductor memory is, for example, a ROM. The image display device 100, the processor 11, and the like, perform various processes according to the present embodiment based on programs stored in the information storage device. That is, the information storage device stores programs that cause the computer to function as each unit of the image display device 100. The computer is a device including an input device, a processor, a storage, and an outputter. Specifically, the program according to the present embodiment is a program that causes the computer to execute each of the steps described below with reference to FIG. 4, and the like.

For example, the program according to the present embodiment causes the computer to function as the image acquirer 110, the object detector 120, the size acquirer 130, the determiner 150, the image quality adjuster 160, and the display controller 170 of the image display device 100.

The method according to the present embodiment may also be applied to the image display method including each of the steps below. The image display method includes a step of acquiring an input image, a step of detecting a predetermined object from the input image, a step of acquiring a size of the predetermined object, a step of determining whether to adjust an image quality for a specific color of the predetermined object based on the size of the predetermined object, a step of adjusting, when it is determined that the image quality is to be adjusted, the image quality of at least a partial region of the input image for the specific color, and a step of controlling a display panel to display the input image having the image quality adjusted. For example, the image display method may include each of the steps described below with reference to FIGS. 4, 6, 8A, 8B, and the like.

### 1.2 Details of Process

FIG. 4 is a flowchart illustrating a process of the image display device 100 according to the present embodiment. The process illustrated in FIG. 4 may be performed on the image of each frame, for example, when video information, which is a set of time-series images, is acquired.

First, in Step S101, the image acquirer 110 acquires the input image. For example, the image acquirer 110 acquires the image of a predetermined one frame included in the video information acquired via the tuner 12, or the like, and outputs the image to the object detector 120.

In Step S102, the object detector 120 performs an object detection process to detect a predetermined object from the input image acquired from the image acquirer 110. The process here may be the process to detect the outline of the predetermined object based on a structure (eyes, nose, etc.) included in the object, the process using machine learning such as CNN or YOLO, or the process using other object detection methods, as described above.

FIG. 5 is a diagram illustrating an example of the detection result acquired during the object detection process of the object detector 120. An image IM in FIG. 5 corresponds to the input image. In the example of FIG. 5, the input image (the image IM) includes faces F1 and F2 of two people. In this case, the object detector 120 acquires, for example, the rectangular region D1 including the face F1 and a rectangular region D2 including the face F2 as detection results of the object detection process. For example, the detection result is the information that specifies the rectangular region and may be a set of coordinates of the reference points (e.g., the upper left coordinates and the lower right coordinates) of the rectangular region, a set of the coordinates of the reference point (e.g., the upper left coordinates) of the rectangular region and the lengths in the vertical and horizontal directions, or other information. When a plurality of predetermined objects is detected, the information specifying the rectangular region is obtained for each of the predetermined objects. For example, the detection result may include the number of detected predetermined objects and the information specifying the rectangular region corresponding to each of the predetermined objects.

The detection results are not limited to rectangular regions. For example, when the object detection process is a process to detect the outline of the face from structures such as eyes and nose, the object detector 120 may acquire the region enclosed by the outline as a detection result. In a process using the neural network, instead of processing each detection window, the possibility may be obtained for each pixel in the input image as to whether the pixel belongs to the face. In this case, the detection result may be a set of pixels whose possibility of belonging to the face is equal to or more than a predetermined threshold, and the shape is not limited to a rectangle. For example, the detection result may include the number of predetermined objects detected and the information specifying the region corresponding to each predetermined object. The object detector 120 outputs the detection result to the size acquirer 130.

In Step S103, the size acquirer 130 acquires the size of the predetermined object detected by the object detector 120. When a plurality of objects is detected as illustrated in FIG. 5, the object detector 120 acquires the size of each of the objects. The size here is the information indicating the size and may be the product of the vertical length and the horizontal length of the rectangular region or may be the total number of pixels included in the detection result. The size acquirer 130 outputs the acquired size to the determiner 150. For example, the size acquirer 130 may output the number of predetermined objects detected and the size of each of the predetermined objects to the determiner 150.

In Step S104, the determiner 150 determines whether to adjust the image quality for the specific color included in the predetermined object based on the size output from the size acquirer 130.

For example, when the size of the predetermined object is larger than the predetermined size, the determiner 150 may determine that the image quality for the specific color is to be adjusted. In this way, it is possible to determine whether to adjust the specific color based on the size of the predetermined object itself regardless of the number of pixels corresponding to the specific color. Therefore, when the predetermined object is captured in a large size in the input image, the specific color caused by the predetermined object is adjusted even if part of the skin color region is blocked by a mask, or the like. Therefore, for example, when a human face appears in a large size in the displayed image, there may be a high probability that the image quality of the skin color is adjusted. For example, it is possible to suppress the gap between the memory color and the specific color included in the object displayed in a large size, and therefore it is possible to prevent the user who views the displayed image from feeling strange. On the other hand, when the predetermined object is small, the adjustment of the image quality may be omitted because the effect of the predetermined object on the user is small.

For example, the determiner 150 may obtain an index value based on the size of the predetermined object and determine whether to adjust the image quality for the specific color based on the index value and a predetermined threshold. Thus, it is possible to properly determine whether the size is large. By adjusting the method for calculating the index value and the threshold, it is possible to flexibly change the criteria for determining whether to adjust the image quality for the specific color. For example, the process in Step S104 may include the process of calculating the index value and the process of determining whether the image quality for the specific color needs to be adjusted based on the index value. An example of each process will be described below.

FIG. 6 is a flowchart illustrating the process included in the determination process in Step S104 to obtain a size index value that is an index value for the size. First, in Step S201, the determiner 150 determines whether the number of predetermined objects detected is one or more.

When the number of predetermined objects detected is one or more (Step S201: Yes), the determiner 150 calculates a size statistic based on the size of each of the predetermined objects output from the size acquirer 130 in Step S202.

For example, the determiner 150 may obtain the size of the largest predetermined object among the one or more predetermined objects detected as a size statistic. Alternatively, the determiner 150 may obtain the total, mean, median, or the like, of the sizes of the one or more predetermined objects as a size statistic. In this case, the predetermined objects used to calculate the total, or the like, may be all the predetermined objects detected or the n largest objects in size (n is an integer equal to or more than 2). Here, n may be a fixed value or a value dynamically determined in accordance with the number of predetermined objects detected. Alternatively, the determiner 150 may obtain, as a size statistic, the minimum value among the n largest objects in size included in the one or more predetermined objects.

The determiner 150 may also obtain, as a size statistic, the ratio of the maximum value described above to the entire input image. For example, the determiner 150 may obtain the size of the input image based on the resolution of the input image. The size of the input image is the product of the number of pixels in the vertical direction and the number of pixels in the horizontal direction. For example, when the maximum value of the size of the predetermined object detected is B and the size of the input image is A, the value C representing the size statistic may be C=(B/A)×100. Here, B may also be replaced with a value such as the total, mean, median, or minimum value, as described above.

The determiner 150 may obtain the index value based on the position of the predetermined object detected from the input image. For example, the determiner 150 may use the position of the predetermined object for the calculation of the size statistic described above. For example, the determiner 150 may multiply the size of each of the predetermined objects obtained by the size acquirer 130 by the weight corresponding to the position and then obtain the size statistic described above. For example, the determiner 150 may use the weight that has a larger value when the position of the predetermined object is closer to the center of the input image and has a smaller value when the position is further from the center. For example, even for the objects having the identical size, the object close to the center of the input image is evaluated to be relatively larger in size, while the object far from the center is evaluated to be relatively smaller in size. In this way, the contribution of the object that is likely to attract the user's attention may be relatively large in the calculation of the size statistic, and therefore it is possible to, for example, suppress a failure in the image quality adjustment on the object that is likely to attract attention.

After the size statistic is calculated, in Step S203, the determiner 150 obtains a size index value based on the comparison process between the size statistic and a predetermined threshold TH. The size index value here is an index indicating whether the size is large or small, e.g., the larger the size, the larger the value of the information. The threshold here may be, for example, a value more than 0 and 100 or less.

For example, when the size statistic is equal to or more than the threshold TH (Step S203: Yes), in Step S204, the determiner 150 sets the size index value to 100. Conversely, when the size statistic is less than the threshold TH (Step S203: No), in Step S205, the determiner 150 determines the size index value based on an interpolation process.

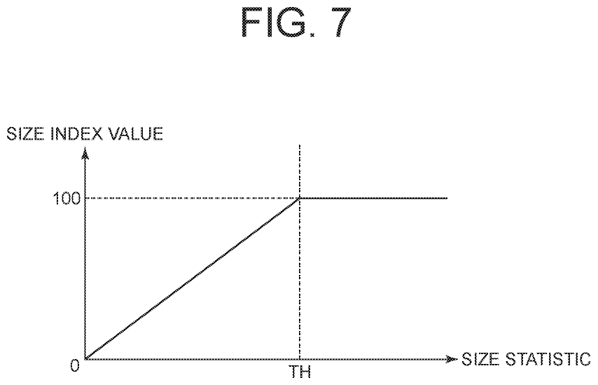

FIG. 7 is a graph illustrating an example of the relationship among the size statistic, the threshold TH, and the size index value. For example, as illustrated in FIG. 7, in Step S205, the determiner 150 may obtain the size index value by linear interpolation. FIG. 7 illustrates an example of the relationship among the size statistic, the threshold TH, and the size index value, and the size index value may be obtained based on other relationships. For example, in the range where the size statistic is less than the threshold TH, an interpolation process using a nonlinear function may be performed.

When the number of predetermined objects detected is 0 (Step S201: No), the size index value is set to 0 in Step S206.

As described above, when a plurality of predetermined objects is detected from the input image, the determiner 150 may obtain an index value based on the size of at least one of the predetermined objects. For example, as described above, the maximum size of the object may be used to calculate an index value, or the average of the sizes of two or more object, or the like, may be used to calculate an index value. In this way, the size of a predetermined object in the input image may be properly evaluated even when there is a plurality of predetermined objects. In other words, it is possible to properly quantify the effect of the predetermined object on the user regardless of the number of the predetermined objects in the input image.

As illustrated in FIG. 7, according to the present embodiment, a conversion process may be performed from the size statistic to the size index value. The size statistic is a value having a maximum value of 100, for example, but in real input images, there are not many cases where the human face covers the entire image. For example, B described above is likely to be smaller than A, and there is a low probability that the size statistic becomes 100 or a value close to 100. In this regard, in the size index value in the example of FIG. 7, a value close to 100, which is the maximum value, may also be properly used. Specifically, the conversion to the size index value makes it possible to adjust the degree of fluctuation of values in a numerical range (e.g., 0 or more and 100 or less). In particular, as described below according to a second embodiment, when the size index value is compared with another index value such as a scene index value, it is possible to properly compare large and small relationships as the degree of fluctuation is aligned in the numerical range of index values. The determiner 150 may use the size statistic itself as the size index value. In this case, Steps S203 to S205 in FIG. 6 may be omitted, and the size statistic obtained in Step S202 is used as the size index value without change.

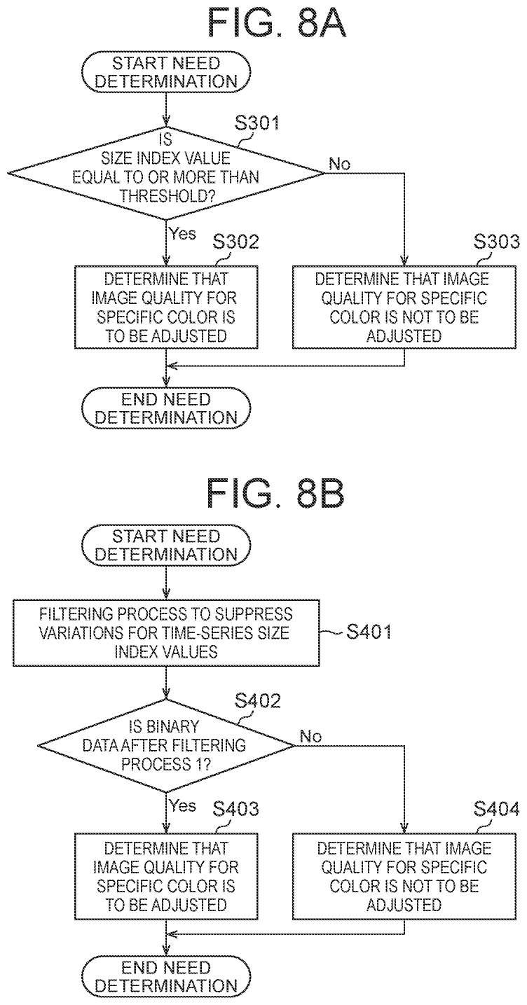

FIG. 8A is a flowchart illustrating a process included in the determination process in Step S104 to determine whether the image quality for the specific color needs to be adjusted based on the index value. The process here may be a process based on the index value and a predetermined threshold TH0. The index value is the size index value described above. The predetermined threshold TH0 here is different information than the threshold TH used for the comparison with the size statistic, but the threshold TH0 and the threshold TH described above may be set to the identical value.

As illustrated in FIG. 8A, first in Step S301, it is determined whether the size index value is equal to or more than the threshold TH0. In the example of FIG. 7, the size index value is 0 or more and 100 or less, and TH0 may be set in the range of more than 0 and 100 or less.

When the size index value is equal to or more than the threshold TH0 (Step S301: Yes), in Step S302, the determiner 150 determines that the image quality for the specific color is to be adjusted. When the size index value is less than the threshold TH0 (Step S301: No), in Step S303, the determiner 150 determines that the image quality for the specific color is not to be adjusted. In this way, it is possible to determine whether the image quality for the specific color needs to be adjusted based on the size of the size index value.

The process of determining whether the image quality for the specific color needs to be adjusted based on the index value is not limited to the process illustrated in FIG. 8A. FIG. 8B is a flowchart illustrating another process included in the determination process in Step S104 to determine whether to adjust the image quality for the specific color based on the index value and a predetermined threshold.

As illustrated in Step S401, the determiner 150 may perform a filtering process to suppress time-series variations for the index value. The determiner 150 determines whether to adjust the image quality based on the index value having undergone the filtering process. By suppressing the time-series variations of the size index value, frequent changes in the determination result may be suppressed even when, for example, the size index value slightly varies in the vicinity of the threshold. As frequent changes in the image quality of the specific color may be suppressed, it is possible to prevent the user from feeling strange.

The filtering process here may include a hysteresis process that makes a threshold determination using a plurality of different thresholds in accordance with the direction of change in the index value and include a chattering filtering process that changes the value on the condition that the identical value is acquired equal to or more than a predetermined number of times. In this way, time-series variations in the index value may be properly suppressed. In the example described below, the chattering filtering process is a process in which the value is changed on the condition that the identical value is acquired equal to or more than the predetermined number of times in a row.

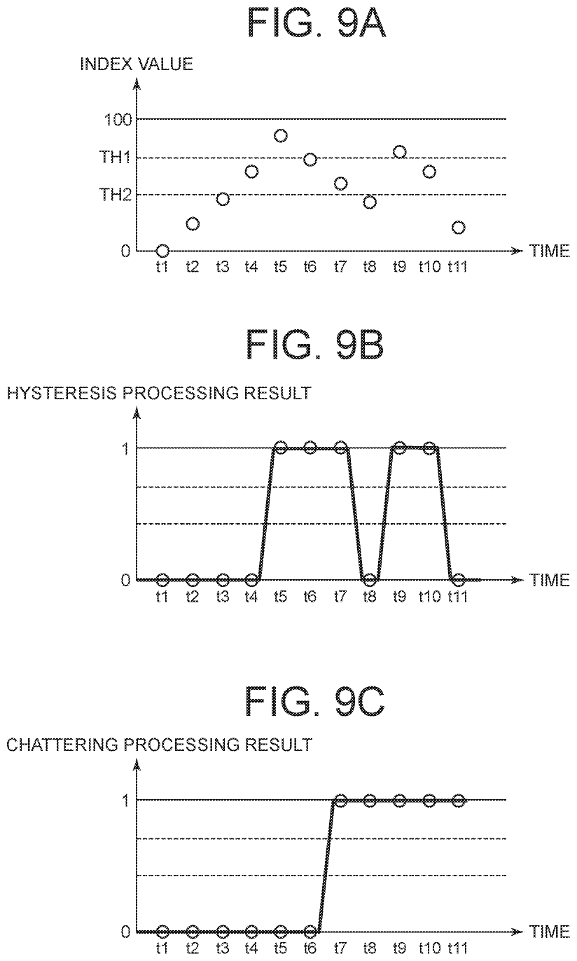

FIGS. 9A to 9C are graphs illustrating specific examples of the filtering process in Step S401. FIG. 9A is a graph illustrating an example of time-series changes in the index value. The horizontal axis in FIG. 9A represents time, and the vertical axis represents index values. The index value according to the present embodiment is the size index value described above. In FIG. 9A, timings t1 to t11 are the timings at which the size index values are obtained and correspond to frames in the video signal, for example. The processing result of the hysteresis process is referred to as a first processing result below.

For example, in the hysteresis process, when the current first processing result is 0, the determiner 150 determines whether to increase the first processing result to 1 based on a comparison process with a relatively large threshold TH1. For example, the determiner 150 outputs 1 as the first processing result when it is determined that the size index value is equal to or more than the threshold TH1. When it is determined that the size index value is less than the threshold TH1, the determiner 150 continuously outputs 0 as the first processing result.

When the current first processing result is 1, the determiner 150 determines whether to decrease the first processing result to 0 based on a comparison process with a threshold TH2 that is smaller than the threshold TH1. For example, the determiner 150 outputs 0 as the first processing result when it is determined that the size index value is less than the threshold TH2. When it is determined that the size index value is equal to or more than the threshold TH2, the determiner 150 continuously outputs 1 as the first processing result.

In summary, the determiner 150 outputs 1 as the first processing result when the size index value is equal to or more than the threshold TH1, outputs 0 as the first processing result when the size index value is less than the threshold TH2, and continuously outputs the value identical to the first processing result one timing earlier when the size index value is equal to or more than the threshold TH2 and less than the threshold TH1.

FIG. 9B is a graph illustrating the processing result of the hysteresis process using the thresholds TH1 and TH2 for the index values illustrated in FIG. 9A. At the timing t1, the size index value is less than the threshold TH2, and therefore the determiner 150 outputs 0 as the first processing result. The same applies to the timings t2 and t3, and the determiner 150 outputs 0 as the first processing result.

At the timing t4, the size index value is equal to or more than the threshold TH2 and less than the threshold TH1. In this case, the first processing result one timing earlier is continuously output, and therefore the determiner 150 outputs 0 as the first processing result.

At the timing t5, it is determined that the size index value is equal to or more than the threshold TH1. Therefore, the determiner 150 outputs 1 as the first processing result.

At the timing t6, the size index value is equal to or more than the threshold TH2 and less than TH1. In this case, the first processing result one timing earlier is continuously output, and therefore the determiner 150 outputs 1 as the first processing result. The same applies to the timing t7.

At the timing t8, it is determined that the size index value is less than the threshold TH2. Therefore, the determiner 150 outputs 0 as the first processing result. The same applies to the following, and the determiner 150 outputs 1 as the first processing result at the timings t9 and t10 and outputs 0 as the first processing result at the timing W.

As illustrated in FIG. 9A, the degree of variation in the size index value is large in this example, but the hysteresis process suppresses the variations in the value. For example, in the example of FIG. 9A, there are many value variations across the threshold TH1 or TH2, but as illustrated in FIG. 9B, the value variations in the processing result of the hysteresis process are suppressed to three times at t5, t8, and t11.

FIG. 9C is a graph illustrating the processing result of the chattering filtering process on the processing result of the hysteresis process illustrated in FIG. 9B. For convenience of explanation, a processing result of the chattering filtering process is also referred to as a second processing result below. For example, the determiner 150 changes the value of the second processing result to the input value on the condition that an input value different from the second processing result one timing earlier was acquired a predetermined number of times in a row. In other words, the input value is not applied to the second processing result when the number of times in a row is less than the predetermined number of time even though the input value different from the second processing result is acquired. FIG. 9C illustrates an example of the case where the predetermined number of times is set to three, but the predetermined number of times may be modified to various values. It is assumed that the initial value of the second processing result is 0.

As illustrated in FIG. 9B, at the timings t1 to t4, the value of the first processing result, which is the input value, is 0 and the value of the second processing result one timing earlier is 0. Therefore, as illustrated in FIG. 9C, the determiner 150 continuously outputs 0 as the second processing result.

At the timing t5, the value of the first processing result, which is the input value, is 1 and is different from the value of the second processing result, 0, one timing earlier. Therefore, the determiner 150 determines whether the number of times in a row is equal to or more than the predetermined number of times. Here, the number of times in a row is 1 and is less than the predetermined number of times, 3, and therefore the input value is not applied. As a result, as illustrated in FIG. 9C, the determiner 150 continuously outputs 0 as the second processing result.

At the timing t6, t00, the value of the first processing result, which is the input value, is 1 and is different from the value of the second processing result, 0, one timing earlier. In this case, the number of times in a row is increased to 2 but is less than the predetermined number of times, 3, and therefore the input value is not applied. As a result, as illustrated in FIG. 9C, the determiner 150 continuously outputs 0 as the second processing result.

At the timing t7, the value of the first processing result, which is the input value, is 1 and is different from the value of the second processing result, 0. In this case, the number of times in a row is increased to 3 and is thus equal to or more than the predetermined number of times, and therefore the input value is applied to the second processing result. As a result, as illustrated in FIG. 9C, the determiner 150 outputs 1 as the second processing result.

After the timing t8, the second processing result one timing earlier is 1, and therefore the number of times in a row with the input value of 0 is compared with the predetermined number of times. For example, at t8 and t11, 0 is acquired as the input value, but in both cases, the number of times in a row is 1 and is less than the predetermined number of times, 3, and therefore the input value is not applied. As a result, as illustrated in FIG. 9C, the determiner 150 continuously outputs 1 as the second processing result at the timings t8 to t11.

As may be seen from the comparison between FIGS. 9B and 9C, the chattering filtering process prevents short-term value variations from being applied to the processing result, and therefore it is possible to further suppress time-series variations in the index value.

With reference back to FIG. 8B, the description will be continued. In Step S402, the determiner 150 determines whether the second processing result, which is the value having undergone the filtering process, is 1. When the second processing result is 1 (Step S402: Yes), in Step S403, the determiner 150 determines that the image quality for the specific color is to be adjusted. When the second processing result is 0 (Step S402: No), in Step S404, the determiner 150 determines that the image quality for the specific color is not to be adjusted. In this way, it is possible to determine whether the image quality for the specific color needs to be adjusted while suppressing time-series variations in the size index value.

The process described above with reference to FIGS. 6 to 8B completes the process of the determiner 150 illustrated in Step S104 of FIG. 4. The determiner 150 outputs, to the image quality adjuster 160, the result of determination as to whether to adjust the image quality for the specific color.

In Step S105, the image quality adjuster 160 determines whether the determination result for adjusting the image quality for the specific color has been obtained. When the determiner 150 determines that the image quality for the specific color is to be adjusted (Step S105: Yes), in Step S106, the image quality adjuster 160 adjusts the image quality for the specific color with regard to the input image. For example, when the predetermined object is a human face, the image quality adjuster 160 performs a process to reduce the saturation of pixels of the color corresponding to the skin color as the memory color is lighter than the actual color. When the predetermined object is a blue sky or a green landscape, the image quality adjuster 160 performs a process to increase the saturation of blue and green pixels as the memory color is darker than the actual color.

In Step S106, the image quality adjuster 160 may adjust the image quality of the region of the input image corresponding to the predetermined object detected by the object detector 120 and may not adjust the image quality of the other regions of the input image. In this way, the correction target of the image quality for the specific color may be limited to the predetermined object. For example, when the image includes an object with a skin color different from that of the human's skin, the image quality is not adjusted for the object, and thus it is possible to prevent the user from feeling strange.

The region corresponding to the predetermined object here is, for example, the rectangular region D1 or the rectangular region D2 itself, which is the detection result illustrated in FIG. 5, but does not need to be an exact match. For example, the adjustment on the image quality for the specific color targeted for the face F1 may be performed on a region where part of the rectangular region D1 is excluded. For example, the adjustment target region may be a region including equal to or more than a predetermined percentage of D1. Alternatively, the adjustment target region may include a region near the rectangular region D1. For example, the adjustment target region may be a region where the percentage of a region other than the rectangular region D1 in the region is less than a predetermined percentage.

Alternatively, the image quality adjuster 160 may adjust the image quality of the region including the region of the input image corresponding to the predetermined object detected by the object detector 120 and a region not corresponding to the predetermined object. The target region for the image quality adjustment here may be a region having a size equal to or more than a predetermined percentage of the size of the entire input image. For example, the image quality adjuster 160 may adjust the image quality for the specific color targeted for the entire input image. In this way, the processing load may be reduced as there is no need to strictly set the target region for the image quality adjustment.

When the determiner 150 determines that the image quality for the specific color is not to be adjusted (Step S105: No), the image quality adjuster 160 skips the adjustment on the image quality for the specific color illustrated in Step S106.

Although not illustrated in FIG. 4, the image quality adjuster 160 may perform a process to increase at least one of the brightness and saturation of the input image without limitation to the specific color. In this way, vivid colors may be expressed regardless of the standard of television broadcast. For example, when the image quality for the specific color is adjusted, the image quality adjuster 160 may perform both image quality adjustment for the specific color and image quality adjustment not exclusively for the specific color. When the image quality for the specific color is not adjusted, the image quality adjuster 160 may only perform image quality adjustment not exclusively for the specific color.

In Step S107, the display controller 170 controls the display panel 16 to display the input image having undergone the image quality adjustment. The input image having undergone the image quality adjustment here is, in a narrow sense, the input image having the image quality for the specific color adjusted. The input image having undergone the image quality adjustment may be the input image having undergone both the image quality adjustment for the specific color and the image quality adjustment not exclusively for the specific color, or may be the input image having undergone only the image quality adjustment not exclusively for the specific color.

### 2. Second Embodiment

FIG. 10 is a diagram illustrating an example of the configuration of the image display device 100 according to the present embodiment. Compared to the configuration illustrated in FIG. 3, the scene acquirer 140 is added to the configuration. The scene acquirer 140 determines the scene of the input image output from the image acquirer 110 and acquires a scene determination result. For example, as described below, the scene acquirer 140 may determine, for each of candidate scenes, the possibility that the input image corresponds to the candidate scene. The candidate scenes here include human faces, blue skies, green landscapes, animations, etc.

The image acquirer 110 is the same as that in the first embodiment except that the input image is output to the object detector 120 and the scene acquirer 140. The determiner 150 determines whether the image quality for the specific color needs to be adjusted based on the scene determination result by the scene acquirer 140 in addition to the size index value. The details of the process by the determiner 150 will be described below. The object detector 120, the size acquirer 130, the image quality adjuster 160, and the display controller 170 are the same as those in the first embodiment.

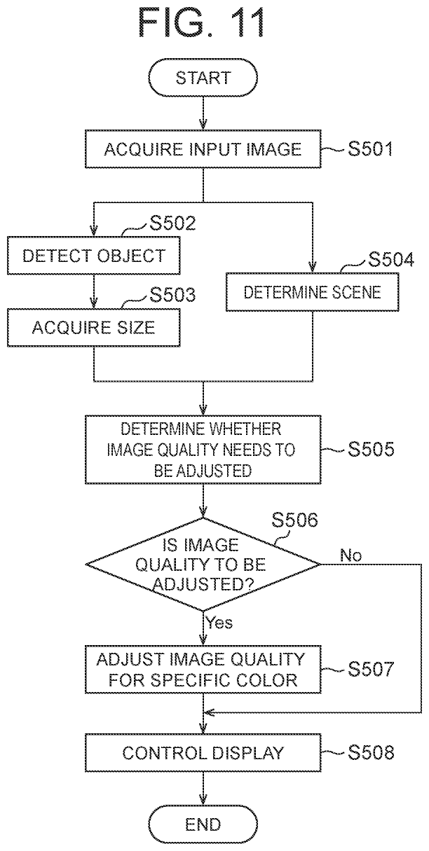

FIG. 11 is a flowchart illustrating a process of the image display device 100 according to the present embodiment. The process illustrated in FIG. 11 may be performed for the image of each frame when, for example, video information, which is a set of time-series images, is acquired.

First, in Step S501, the image acquirer 110 acquires the input image. In Step S502, the object detector 120 performs an object detection process to detect the predetermined object from the input image acquired from the image acquirer 110. In Step S503, the size acquirer 130 obtains the size of the predetermined object detected by the object detector 120. The process from Steps S501 to S503 is similar to the process from Steps S101 to S103 in FIG. 4. For example, in Step S503, the size acquirer 130 outputs the number of predetermined objects detected and the size of each of the predetermined objects to the determiner 150.

In Step S504, the scene acquirer 140 determines the scene of the input image and acquires the scene determination result. For example, the scene acquirer 140 may use a classification model acquired by machine learning to perform scene determination. The process described below is an example of scene determination, and scene determination may be performed using other machine learning such as Support Vector Machine (SVM), or methods different from machine learning. The processes illustrated in Steps S502 and S503 and the process illustrated in Step S504 may be executed in parallel or sequentially.

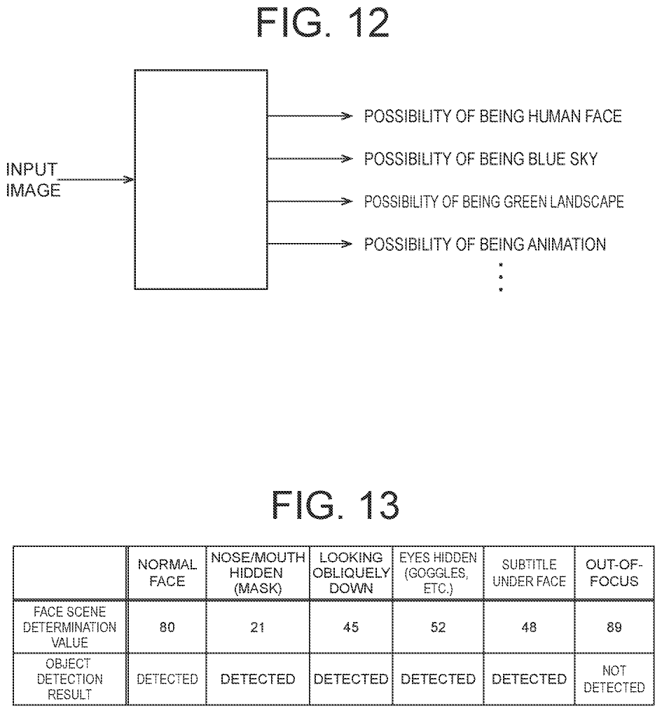

FIG. 12 is a diagram illustrating input and output during scene determination. Scene determination may be performed by using, for example, a classification model using the CNN described above. The input to the CNN is the input image output from the image acquirer 110. The input is not limited to the input image itself, but may be the result of some pre-processing performed on the input image.

The output from the CNN may be, for example, the possibility about each of the candidate scenes. The candidate scenes here include, for example, human faces, blue skies, green landscapes, and animations described above. The candidate scenes are not limited thereto, but may include various scenes such as buildings, food, and animals. For example, the CNN outputs four values: the possibility that the scene of the input image is a human face, the possibility that the scene of the input image is a blue sky, the possibility that the scene of the input image is a green landscape, and the possibility that the scene of the input image is an animation. Each value may be, for example, a numerical value of 0 or more and 100 or less. Hereinafter, the possibility of being a human face is referred to as a face scene determination value, the possibility of being a blue sky as a blue sky scene determination value, the possibility of being a green landscape as a green scene determination value, and the possibility of being an animation as an animation scene determination value.

For example, the CNN is acquired by machine learning based on training data. The training data here is the data in which the scene classification result is assigned as correct data to a learning image. The scene classification result is acquired, for example, by input from a user who has viewed the learning image. For example, when the user determines that the learning image is the image that captures a human face, the data in which the face scene determination value is 100 and the blue sky scene determination value, the green scene determination value, and the animation scene determination value are 0 is assigned as the correct data. One image may correspond to a plurality of scenes, such as a blue sky and a human face are included in one learning image. In this example, the data in which the face scene determination value and the blue sky scene determination value are 100 and the green scene determination value and the animation scene determination value are 0 is assigned as the correct data. There are widely known methods for generating a trained model for image classification, and these methods may be widely applied according to the present embodiment.

For example, the image display device 100 includes a storage (not illustrated) storing a CNN that is a trained model. The storage here may be the memory 14 of the television receiver 10 illustrated in FIG. 2. The scene acquirer 140 reads the CNN from the storage and inputs the input image to the CNN to obtain the four values: the face scene determination value, the blue sky scene determination value, the green scene determination value, and the animation scene determination value. The scene acquirer 140 outputs at least one of these values to the determiner 150 as a scene determination result.

The determiner 150 determines whether to adjust the image quality for the specific color included in the predetermined object based on the size output from the size acquirer 130 and the scene determination result output from the scene acquirer 140. For example, the determiner 150 may acquire the size index value based on the size and the scene index value based on the scene determination result and obtain the index value based on the size index value and the scene index value. The determiner 150 determines whether the image quality for the specific color needs to be adjusted based on the index value. This makes it possible to determine whether the image quality needs to be adjusted based on different information: the object detection result and the scene determination result. Thus, the determination accuracy may be improved.

In this case, the scene acquirer 140 may obtain, as the scene determination result, the possibility that the input image is a scene corresponding to the predetermined object. Further, the determiner 150 may acquire, as the scene index value, the possibility that the scene corresponds to the predetermined object. For example, when the predetermined object is a human face, the scene acquirer 140 acquires the information including at least the face scene determination value as a scene determination result, and the determiner 150 acquires the face scene determination value as a scene index value. When the predetermined object is a blue sky, the scene acquirer 140 may acquire the information including at least the blue sky scene determination value as a scene determination result, and the determiner 150 may acquire the blue sky scene determination value as a scene index value. Similarly, when the predetermined object is a green landscape, the scene acquirer 140 acquires the information including at least the green scene determination value as a scene determination result, and the determiner 150 acquires the green scene determination value as a scene index value. In this way, the result of object detection for the predetermined object and the result of scene determination for the predetermined object may be used for index value calculation. The use of the result of different determinations for the identical object may improve the accuracy at which it is determined whether the image quality needs to be adjusted.

The difference between object detection and scene determination will be described here. For example, object detection is a process to determine the specific position and size in addition to the presence of the predetermined object and, in some cases, includes a process to detect detailed shapes such as parts, e.g., eyes and nose. Therefore, it is possible to obtain more detailed information about the predetermined object than scene determination, and the detection accuracy of the predetermined object is high. Scene determination, on the other hand, is a process to determine the degree to which the entire input image matches the features of the candidate scene. Therefore, although the number, size, position, and the like, of the specific object are not obtained, it is possible to make determinations about various candidate scenes, as illustrated in FIG. 12.

FIG. 13 is a table illustrating an example of the relationship among the mode of the input image, the face scene determination value, and the object detection result. As described above, the face scene determination value is a numerical value of 0 or more and 100 or less indicating the possibility that the input image is a scene including a human face. The object detection result indicates whether an object was detected from the input image.

As illustrated in FIG. 13, when the image is captured in a normal mode with no object blocking the face, the face scene determination value is somewhat a high value, and the face is detected as a result of object detection. Therefore, in this case, both the size index value based on the object detection result and the scene index value (face scene determination value) are information reflecting the predetermined object (human face) included in the input image.

As illustrated in FIG. 13, the face scene determination value may decrease when the nose or mouth is shielded by a mask, etc., when the person is looking obliquely, when the eyes are shielded by goggles, etc., or when subtitles are displayed around the face. It is considered that this is because the input image deviates from the state where the input image is likely to be a scene including the face as some parts of the face are shielded or other information such as subtitles are included in a mixed manner. In this case, the scene index value does not properly reflect the predetermined object (human face) included in the input image, and the use of only the scene index value may result in a determination that image quality adjustment for the skin color is unnecessary. On the other hand, object detection may properly detect face regions because even if some parts are missing, the remaining parts may be detected. The same applies to cases where the face is not oriented to the front, which distorts the shape of the parts on the image or where other information such as subtitles is included in a mixed manner, etc., and object detection is possible. Therefore, when the target is the input image in which a human face appears in these modes, the use of the size index value based on the object detection result may suppress the occurrence of a failure in image quality adjustment. The face scene determination values illustrated in FIG. 13 are examples, and the face scene determination value does not always decrease in the cases of “nose/mouth hidden”, “looking obliquely down”, “eyes hidden”, and “subtitle under the face”. That is, even if any of these cases is applied, there may be cases in which scene determination properly detects the scene including a human face.

When a human face on the image is blurred because the person is out of focus, for example, parts are not properly detected, and it may be determined that the predetermined object is not detected. In this case, the use of only the size index value based on the object detection result may result in a determination that the image quality adjustment for the skin color is unnecessary. On the other hand, while detailed structures may be crushed in an out-of-focus state, the entire input image tends to deviate little from the in-focus state. During scene determination, the possibility of being the scene including a face is determined as the entire input image, and therefore, even when the image is out-of-focus, the face scene determination value is likely to be determined to be high if the image includes a person. Therefore, the use of the scene index value may suppress the occurrence of a failure in the image quality adjustment. FIG. 13 illustrates that it may be difficult to perform face detection by the object detection process in the case of “out-of-focus”, and even in the case of “out-of-focus”, a human face may be properly detected by the object detection process.

As may be seen from the example in FIG. 13, suitable face modes are different for object detection and scene determination. Therefore, the use of both the size index value based on object detection and the scene index value based on scene determination makes it possible to properly determine whether the image quality for the specific color needs to be adjusted regardless of the face mode in the input image.

For example, in Step S505 of FIG. 11, the determiner 150 obtains the size index value by the same method as that in the first embodiment and also acquires the scene index value based on the output from the scene acquirer 140. The determiner 150 may acquire the maximum value between the size index value and the scene index value as the index value used to determine whether the image quality for the specific color needs to be adjusted. For example, in the example of FIG. 12, the size index value is more likely to be used as the index value in the mode of nose/mouth hidden, looking diagonally down, eyes hidden, subtitles under the face, etc., and the scene index value is more likely to be used as the index value in the mode of the out-of-focus condition. In this way, even when the mode of the input image changes, the information appropriate for the mode is used as the index value, and therefore the occurrence of a failure in the image quality adjustment for the specific color may be prevented.

The process after the index value is obtained may be the same as that in the first embodiment. For example, as illustrated in FIG. 8A, the determiner 150 may determine whether to adjust the image quality for the specific color based on the comparison process between the index value and the threshold TH0. Alternatively, as illustrated in FIG. 8B, the determiner 150 may perform the process to suppress time-series changes in the index value (Step S401) and then determine whether to adjust the image quality for the specific color based on the processed value. For example, the determiner 150 acquires the size index value and the scene index value in each of the frames and obtains the larger one as the index value in the frame. Then, the process described above with reference to FIGS. 9A to 9C may be performed on the obtained time-series index values to obtain index values with time-series changes suppressed.

The process of Steps S506 to S508 is similar to the process of Steps S105 to S107 in FIG. 4, and therefore detailed descriptions are omitted.

When scene determination is performed, the determiner 150 may perform scene determination for a plurality of candidate scenes in Step S505, and the image quality adjuster 160 may adjust the image quality for the specific color in accordance with the result of the scene determination in Step S507. A specific example will be described below.

In the example described above, the image quality for the human skin color is adjusted by using the size index value based on the detection result of the human face and the face scene determination value that is a scene index value. In this case, the image quality adjustment may be omitted for the blue region of the blue sky and the green region of the green landscape as the specific colors. However, as described above with reference to FIG. 12, the result of the scene determination may include the possibility (blue sky scene determination value) of being the scene including a blue sky or the possibility (green scene determination value) of being the scene including a green landscape. As the memory colors of blue skies and green landscapes are more vivid than their actual colors, it is effective to adjust the image qualities of the blue color of blue skies and the green color of green landscapes. Therefore, it may be determined whether the image quality for the specific color needs to be adjusted based on the blue sky scene determination value and the green scene determination value. For example, the image quality may be adjusted to increase the saturation of the blue region of the blue sky when the blue sky scene determination value is large and to increase the saturation of the green region of the green landscape when the green scene determination value is large. In this way, it may be determined whether the image quality needs to be adjusted even for the specific colors included in an object that is not an object detection target.

The same applies to the case where the predetermined object changes. For example, when the predetermined object is a blue sky, the determiner 150 determines whether to increase the saturation of the blue region based on the larger one of the size index value based on the detection result of the blue sky and the blue sky scene determination value. Further, the determiner 150 may use the face scene determination value and the green scene determination value without change for the human face and the green landscape to determine whether the image quality needs to be adjusted for the skin color region and the green color region.

There may be more than two predetermined objects. For example, the object detector 120 may perform both the detection process of a human face and the detection process of a blue sky. In this case, the determiner 150 determines whether to decrease the saturation of the skin color region based on the size index value based on the detection result of a human face and the face scene determination value. Further, the determiner 150 determines whether to increase the saturation of the blue region based on the size index value based on the detection result of the blue sky and the blue sky scene determination value. For a green landscape, the determiner 150 may use the green scene determination value without change to determine whether the image quality needs to be adjusted for the green region of the green landscape.

Obviously, the object detector 120 may perform an object detection process individually on a human face, a blue sky, and a green landscape as the predetermined object. In this case, the determiner 150 uses both the object detection results and the scene determination results for all the skin color region, the blue color region, and the green color region to determine whether the image quality needs to be adjusted.

As described above, according to the present embodiment, the predetermined object may be a human face, a blue sky, a green landscape, or any other object. The object targeted for the image quality adjustment for the specific color is not limited to one object, but may be two or more objects among a human face, a blue sky, and a green landscape, for example, as described above. In this case, for the object that is a target for the object detection process, both the object detection result and the scene determination result are used so that it is possible to improve the accuracy at which it is determined whether the image quality needs to be adjusted.

### 3. Third Embodiment

In the example described according to the second embodiment, when the size index value based on the object detection result and the scene index value based on the scene determination result are acquired, the larger one of the values is used as the index value. However, the method for acquiring the index value is not limited thereto. A specific example will be described below. The process illustrated in FIG. 11 except for Step S505 is the same as that in the second embodiment.

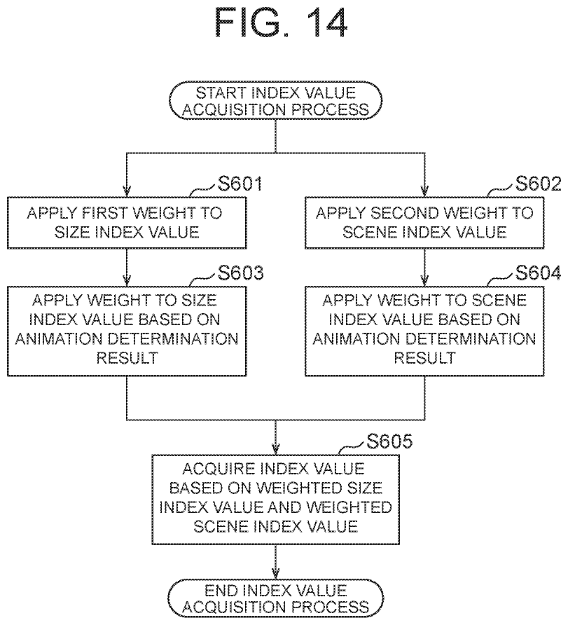

FIG. 14 is a flowchart illustrating the process of acquiring the index value according to the present embodiment. It is assumed that, before the process illustrated in FIG. 14, the determiner 150 has acquired the size index value and the scene index value.

In Step S601, the determiner 150 applies a first weight to the size index value. In Step S602, the determiner 150 applies a second weight to the scene index value. Applying a weighting here is the process of multiplying the size index value by the first weight and multiplying the scene index value by the second weight, but other weighting processes may be used. Here, the first weight and the second weight may be identical or different values. The determiner 150 according to the present embodiment obtains an index value based on the weighted size index value and the weighted scene index value, as described below in Step S605.

In this manner, it is possible to correct the contribution of each of the size index value and the scene index value to the determination as to whether the image quality needs to be adjusted. For example, the first weight may be a value of 0 or more and 1 or less, and the closer the value is to 0, the smaller the size index value, and thus the smaller the contribution of the size index value. The second weight may be a value of 0 or more and 1 or less, and the closer the value is to 0, the smaller the scene index value, and thus the smaller the contribution of the scene index value. At least one of the first weight and the second weight may be a value of 1 or more. The method according to the present embodiment allows flexibility in determining either the size index value or the scene index value to be focused on.

For example, the first weight may be a value larger than the second weight. In this case, it is possible to perform the process to put more focus on the size index value than the scene index value. For example, as illustrated in FIG. 13, there are various possible modes of the predetermined object (e.g., a human face) in the input image, but there may be a wide range that enables object detection as compared to scene determination. Specifically, for determination as to whether the image quality for the specific color needs to be adjusted, the size index value based on object detection may be more reliable information than the scene index value. Therefore, by making the first weight larger than the second weight, the process may be performed with more focus on the reliable information. The process according to the present embodiment is not limited thereto, and the values of the first weight and the second weight may be identical, or the second weight may be larger than the first weight.

As illustrated in FIG. 12, the scene acquirer 140 may acquire the scene determination result indicating the possibility that the input image is an animation. The scene determination result here is, for example, the animation scene determination value described above. The determiner 150 may perform a weighting process on at least one of the size index value and the scene index value based on the possibility that the input image is an animation. For example, when the animation scene determination value is large, the determiner 150 may perform a weighting process using a third weight such that at least one of the size index value and the scene index value becomes smaller than that when the value is small. The weight that makes the index value smaller may be another word for the weight in the direction in which it is determined that the image quality for the specific color is not to be adjusted. In the example described in FIG. 14, the determiner 150 performs a weighting process for the size index value in Step S603 and a weighting process for the scene index value in Step S604, but either one of Steps S603 and S604 may be omitted.

For example, the determiner 150 may set a weight of 0 or more and less than 1 as the third weight. For example, the third weight may be a value that becomes 0 when the animation scene determination value is equal to or more than a predetermined threshold and becomes 1 when the animation scene determination value is less than the predetermined threshold. In this case, when it is determined that there is a high probability that the input image is an animation, at least one of the size index value and the scene index value is set to 0. In this way, for example, it is possible to suppress the image quality adjustment for the skin color region in the animation. In animation, adjusting the image quality of pixels corresponding to the skin color may give the user a feeling of strangeness, and therefore the use of the third weight may prevent the occurrence of a feeling of strangeness.

The determiner 150 may perform weighting by multiplying both the size index value and the scene index value by the third weight. In this way, both the index values become smaller, which makes the image quality adjustment for the specific color unlikely. The process according to the present embodiment is not limited thereto, and the determiner 150 may perform weighting by multiplying either the size index value or the scene index value by the third weight.

The third weight is not limited to two values, 0 and 1. For example, the third weight may be 1 when the animation scene determination value is 0 and may be 0 when the animation scene determination value is 100, and linear interpolation may be performed when the animation scene determination value is in the range of more than 0 and less than 100. In this way, a weight may be applied in a flexible manner in accordance with the animation scene determination value. The range of the third weight is not limited thereto, and a value more than 0 may be set when the animation scene determination value is 100. For example, the value of the third weight is set to 0.5 when the animation scene determination value is 100, and thus the third weight may be set in a range of 0.5 or more and 1 or less. The third weight is set to a value less than 1 when the animation scene determination value is 0 so that the upper limit of the third weight may be changed. The interpolation process in the range of more than 0 and less than 100 of the animation scene determination value is not limited to linear interpolation, but interpolation processing using a nonlinear function may be performed.

In FIG. 14, the process (Steps S601 and S603) for the size index value and the process (Steps S602 and S604) for the scene index value may be performed in parallel or sequentially. After the weighting process is completed, in Step S605, the determiner 150 acquires the index value for determining whether the image quality for the specific color needs to be adjusted based on the size index value and the scene index value after weighting. Specifically, the determiner 150 compares the size index value after weighting and the scene index value after weighting and acquires the larger value as the index value. The process after acquiring the index value is the same as those in the first embodiment and the second embodiment, and the process illustrated in FIG. 8A may be executed, or the process illustrated in FIG. 8B may be executed.

In the example described above, the third weight applied to at least one of the size index value and the scene index value is adjusted in accordance with the possibility of being an animation. However, according to the present embodiment, other image quality adjustments may be made based on the possibility of being an animation. For example, the image quality adjuster 160 may change the specific content of the image quality adjustment for the specific color based on the possibility of being an animation. For example, in the example described above, the image quality adjustment for the specific color is an adjustment to bring the expression of the specific color closer to the memory color. Conversely, the image quality adjuster 160 may adjust the expression of the specific color to be closer to the memory color, for example, when the possibility of being an animation is less than a predetermined value and may adjust the specific color to be closer to a color different from the memory color when the possibility of being an animation is equal to or more than the predetermined value. More broadly, the image quality adjuster 160 may determine the target color in the image quality adjustment for the specific color based on the possibility of being an animation (animation scene determination value). Here, the target color is information specified by a group of values for brightness, saturation, and hue. In this way, it is possible to achieve the image quality adjustment suitable for the case where the input image (video signal) is an animation and the other cases. The animation scene determination value may also be used to determine the target color in the image quality adjustment for a color different from the specific color. Various other modifications are possible for specific processes.

Although the present embodiment has been described in detail as above, those skilled in the art may easily understand that many modifications are possible without substantially deviating from new matters and effects of the present embodiment. Therefore, it is assumed that all such modifications are included in the scope of the present disclosure. For example, a term described in the specification or drawings at least once together with a term having a broader meaning or the same meaning may be replaced with the different term anywhere in the specification or drawings. All combinations of the present embodiment and modifications are also included in the scope of the present disclosure. The configuration, operation, and the like, of the image display device, the television receiver, and the like, are also not limited to those described in the present embodiment, and various modifications are possible.

What is claimed is:

1. An image display device comprising:
an image acquirer that acquires an input image;
an object detector that detects a predetermined object from the input image;
a size acquirer that acquires a size of the predetermined object;
a determiner that determines whether to adjust an image quality for a specific color of the predetermined object based on the size of the predetermined object;
an image quality adjuster that adjusts, when the determiner determines that the image quality is to be adjusted, the image quality of at least a partial region of the input image for the specific color; and
a display controller that controls a display panel to display the input image having the image quality adjusted.

2. The image display device according to claim 1, wherein the determiner determines that the image quality for the specified color is to be adjusted when the size of the predetermined object is larger than a predetermined size.

3. The image display device according to claim 1, wherein the determiner obtains an index value based on the size of the predetermined object and determines whether to adjust the image quality for the specific color based on the index value and a predetermined threshold.

4. The image display device according to claim 3, wherein when the predetermined object includes a plurality of predetermined objects detected from the input image, the determiner obtains the index value based on the size of at least one of a plurality of the predetermined objects.

5. The image display device according to claim 4, wherein the determiner obtains the index value based on a position of the predetermined object detected from the input image.

6. The image display device according to claim 3, further comprising a scene acquirer that determines a scene of the input image and acquires a scene determination result, wherein
the determiner acquires a size index value based on the size and a scene index value based on the scene determination result and obtains the index value based on the size index value and the scene index value.

7. The image display device according to claim 6, wherein the scene acquirer acquires a possibility that the input image is a scene corresponding to the predetermined object as the scene determination result.

8. The image display device according to claim 6, wherein the determiner applies a first weight to the size index value, applies a second weight to the scene index value, and obtains the index value based on the weighted size index value and the weighted scene index value.

9. The image display device according to claim 6, wherein
the scene acquirer acquires the scene determination result indicating a possibility that the input image is an animation, and
the determiner performs a weighting process on at least one of the size index value and the scene index value based on the possibility that the input image is an animation.

10. The image display device according to claim 3, wherein
the determiner performs a filtering process on the index value to suppress time-series variations, and
the image quality adjuster adjusts the image quality based on the index value having undergone the filtering process.

11. The image display device according to claim 1, wherein the image quality adjuster adjusts the image quality of a region of the input image corresponding to the predetermined object detected by the object detector and does not adjust the image quality of the other regions of the input image.

12. The image display device according to claim 1, wherein the image quality adjuster adjusts the image quality of a region of the input image including a region corresponding to the predetermined object detected by the object detector and a region not corresponding to the predetermined object.

13. An image display method comprising:
acquiring an input image;
detecting a predetermined object from the input image;
acquiring a size of the predetermined object;
determining whether to adjust an image quality for a specific color of the predetermined object based on the size of the predetermined object;
adjusting, when it is determined that the image quality is to be adjusted, the image quality of at least a partial region of the input image for the specific color; and
controlling a display panel to display the input image having the image quality adjusted.
